(19) United States
(12) Patent Application Publication
(10) Pub. No.: US 2026/0098547 A1
(43) Pub. Date: Apr. 9, 2026

(54) LIFT FAN ASSEMBLY FOR AN AIRCRAFT

(71) Applicant: General Electric Company, Evendale, OH (US)

(72) Inventors: Scott G. Edens, Milford, OH (US); Jeffrey D. Rambo, Mason, OH (US)

(21) Appl. No.: 18/909,417

(22) Filed: Oct. 8, 2024

(51) Int. Cl. F04D 29/38

(52) U.S. Cl. CPC F04D 29/384; F05D 2220/323; F05D 2220/36

(57) ABSTRACT

Lift fan assembly for an aircraft, including a rotor and an inlet nozzle. The rotor includes a fan having a plurality of fan blades and a plurality of outer airfoils. The plurality of outer airfoils is connected to the fan blades to rotate the plurality of fan blades. The inlet nozzle is positioned and oriented to direct rotating air in a rotating airflow direction to impinge on outer airfoils of the plurality of outer airfoils and to rotate the plurality of outer airfoils. The rotating airflow direction can be transverse to a radial direction and have a component in a direction tangential to the circumferential direction. The fan blades can be rotatable to generate a column of propulsor discharge air, and the lift fan assembly can include a discharge assembly with a discharge nozzle positioned to discharge the rotating air into the column of propulsor discharge air.

### TECHNICAL FIELD

The present disclosure relates to a lift fan assembly for an aircraft.

### BACKGROUND

Some aircraft may be vertical takeoff and landing (VTOL) aircraft or short takeoff and landing (STOL) aircraft that can takeoff and land vertically or with only a short runway, yet have high cruise speeds of conventional aircraft. Such aircraft can include systems to produce lift for takeoff and landing, apart from wings.

### BRIEF DESCRIPTION OF THE DRAWINGS

Features and advantages of the present disclosure will be apparent from the following description of various exemplary embodiments, as illustrated in the accompanying drawings, wherein like reference numbers generally indicate identical, functionally similar, and/or structurally similar elements.

FIG. 1 is a schematic view of an aircraft having lift fan assemblies according to an embodiment of the present disclosure.

FIG. 2A is a schematic, cross-sectional view, taken along line 2A-2A in FIG. 1, of one turbine engine of the aircraft shown in FIG. 1.

FIG. 2B is a schematic, cross-sectional view similar to FIG. 2A of a turbine engine that may be used in the aircraft shown in FIG. 1, showing an alternative rotating air source for the lift fan assemblies.

FIG. 3 is a top view of one of the lift fan assemblies of the aircraft shown in FIG. 1.

FIG. 4 is schematic view of the lift fan assembly shown in FIG. 3, showing the outlet side of the lift fan assembly.

FIG. 5 is a schematic view of the rotor of the lift fan assembly shown in FIGS. 3 and 4.

FIG. 6 is a schematic view of the stator of the lift fan assembly shown in FIGS. 3 and 4.

FIG. 7 is a side view of the lift fan assembly of FIGS. 3 and 4 with an outer wall removed to show outer airfoils of the rotor in an outer airfoil passage of the stator.

FIG. 8 is a schematic view of the lift fan assembly taken along the centerline in FIG. 7.

FIG. 9 is a detail view showing a portion of an outer band of a rotor with outer airfoils thereon and a portion of a discharge assembly of a stator.

FIG. 10 shows a configuration for a plurality of lift fan assemblies formed in a portion of an aircraft, such as one of the wings.

FIG. 11 is a schematic view, taken from a perspective similar to that of FIG. 8, of another lift fan assembly.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the scope of the disclosure as claimed.

Various embodiments are discussed in detail below. While specific embodiments are discussed, this is done for illustration purposes only. A person skilled in the relevant art will recognize that other components and configurations may be used without departing from the present disclosure.

As used herein, the terms “first” and “second” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle.

The terms “upstream” and “downstream” refer to the relative direction with respect to fluid flow in a fluid pathway. For example, “upstream” refers to the direction from which the fluid flows, and “downstream”refers to the direction to which the fluid flows.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

As used herein, the terms “axial” and “axially” refer to directions and orientations that extend parallel to a centerline of the turbine engine or the lift fan assembly. Moreover, the terms “radial” and “radially” refer to directions and orientations that extend perpendicular to the centerline of the turbine engine or the lift fan assembly. In addition, as used herein, the terms “circumferential” and “circumferentially” refer to directions and orientations that extend arcuately about the centerline of the turbine engine or the lift fan assembly.

The singular forms “a,” “an,” and “the” include plural references unless the context clearly dictates otherwise.

Here and throughout the specification and claims, range limitations are combined and interchanged. Such ranges are identified and include all the sub-ranges contained therein unless context or language indicates otherwise. For example, all ranges disclosed herein are inclusive of the endpoints, and the endpoints are independently combinable with each other.

As noted above, some aircraft are VTOL aircraft or STOL aircraft that are designed to takeoff and land vertically or with short runways. A lift fan can be used to provide the lift for the takeoff and the landing. The lift fan of the present disclosure is a tip-turbine lift fan that is powered by an airflow, such as exhaust from the turbine engine. The lift fans disclosed herein include features for efficient operation, such as the direction of the airflow used to power and to rotate the lift fan. The lift fans disclosed herein also mix or otherwise direct the exhaust used to power the lift fan into the column of air produced by the lift fan. Discharging the exhaust in such a manner results in mixing of the hot exhaust with a cool column of air produced by the lift fan to lower the temperature of the exhaust and also to attenuate the acoustic energy of the exhaust, reducing the total sound produced by the lift fan.

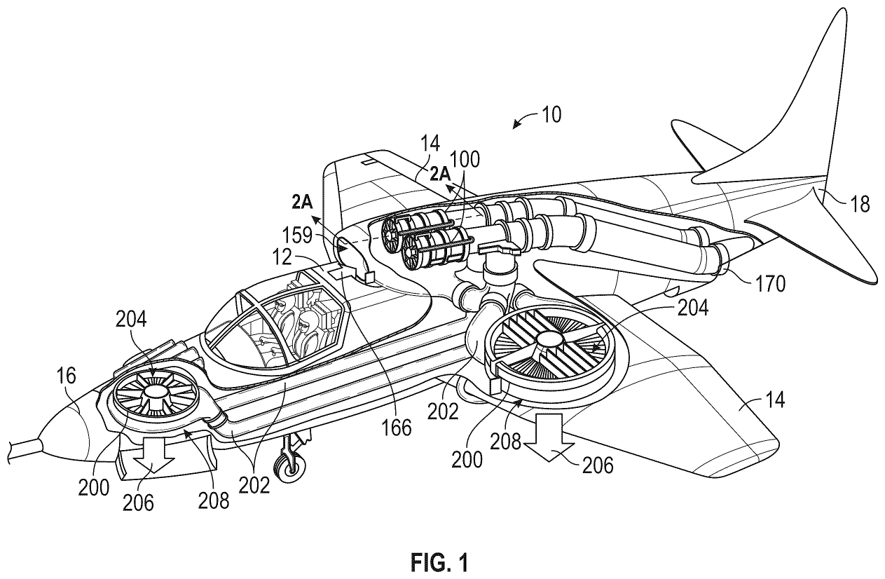

FIG. 1 is a schematic view of an aircraft 10 having one or more lift fan assemblies 200. The aircraft 10 shown in FIG. 1 is an airplane and includes a fuselage 12 with wings 14 attached to the fuselage 12. The fuselage 12 includes a nose section 16 and a tail section 18, which can be an empennage. Although the aircraft 10 shown in FIG. 1 is an airplane, the embodiments described herein can also be applicable to other aircraft, including, for example, unmanned aerial vehicles (UAVs).

The aircraft 10 also includes a propulsion system that produces a propulsive thrust required to propel the aircraft 10 in flight, during taxiing operations, and the like. The propulsion system for the aircraft 10 shown in FIG. 1 includes a pair of turbine engines 100. In this embodiment, each turbine engine 100 is housed within the fuselage 12. In other embodiments, however, the turbine engines 100 can have alternative configurations and be coupled to other portions of the aircraft 10. For example, the turbine engines 100 can additionally or alternatively include one or more aspects coupled to other parts of the aircraft 10, such as, for example, an exterior of the fuselage 12 or the tail section 18. In another example, each turbine engine 100 can be attached to one of the wings 14 by a pylon in an under-wing configuration.

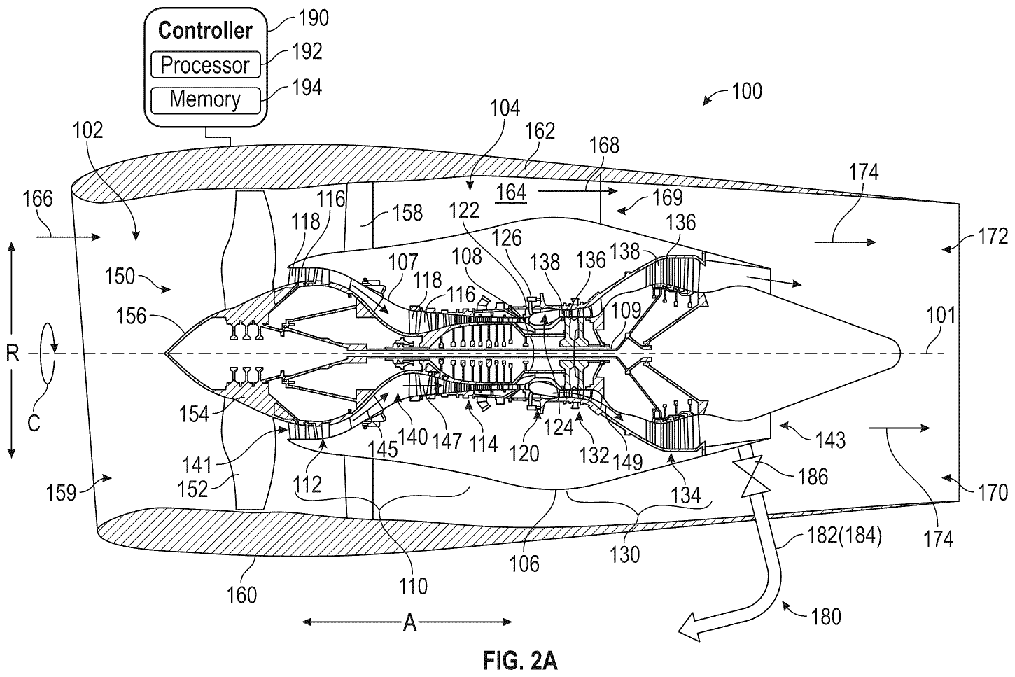

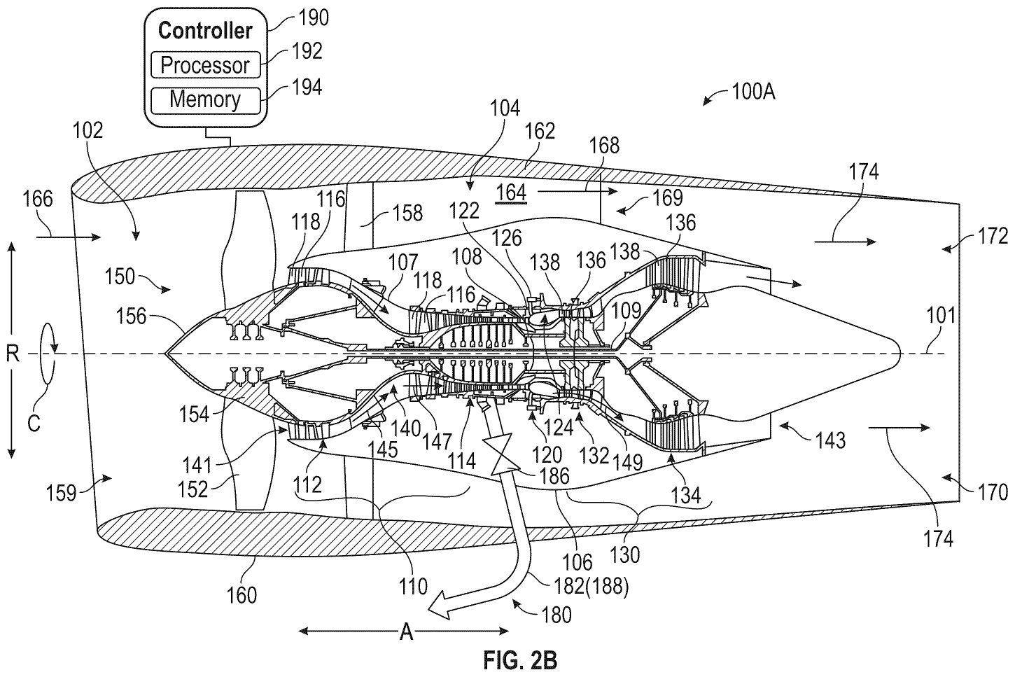

As discussed in more detail below with reference to FIG. 2A, the turbine engines 100 shown in FIG. 1 are gas turbine engines that are each capable of selectively generating a propulsive thrust for the aircraft 10. A volume of air 166 enters the turbine engine 100 through an engine inlet 159. As depicted in FIG. 1, the engine inlet 159 is a common engine inlet for both turbine engines 100. As noted above, other arrangements and positioning of the turbine engines 100 may be used and the engine inlet 159 may be separate for each turbine engine 100. As discussed in more detail below, a portion of the volume of air 166, is compressed by a compressor section 110 (FIG. 2A), and mixed with fuel to form a fuel and air mixture. The fuel and air mixture is combusted, generating combustion products (combustion gases), in a combustion section 120 (FIG. 2A). After flowing through a turbine section 130 (FIG. 2A), the combustion gases are exhausted from the turbine engine 100 through an engine exhaust nozzle 170 to provide propulsive thrust.

The aircraft 10 includes a plurality of lift fan assemblies 200. One or more lift fan assemblies 200 may be located in the wings 14. FIG. 1 depicts one lift fan assembly 200 in the port wing 14 and another lift fan assembly 200 may be located in the starboard wing 14. The aircraft 10 depicted in FIG. 1 also includes a lift fan assembly 200 located in the nose section 16. Other configurations may be used, however, with the plurality of lift fan assemblies 200 located and arranged on other portions of the aircraft 10. Each lift fan assembly 200 is powered by air, which is referred to herein as rotating air 182 (FIG. 2A), from one or more of the turbine engines 100. Each lift fan assembly 200 is thus fluidly connected to at least one of the turbine engines 100 by a rotating air flow path 202. The rotating air flow path 202 may be defined by a fluid conduit such as a duct, a tube, a pipe, or the like.

When driven by the rotating air 182 (FIG. 2A), the lift fan assembly 200 draws air in from an inlet side 204 of the lift fan assembly 200 and discharges a column of propulsor discharge air 206 from an outlet side 208 of the lift fan assembly 200. As depicted in FIG. 1, each lift fan assembly 200 is oriented with the inlet side 204 being an upper side of the lift fan assembly 200 and the outlet side 208 being a lower side of the lift fan assembly 200. In this orientation, the lift fan assembly 200 is oriented on the aircraft 10 such that the column of propulsor discharge air 206 produces lift for vertical takeoff and landing, or short take off and landing of the aircraft 10.

FIG. 2A is a schematic, cross-sectional view of a turbine engine 100 that may be used on the aircraft 10. More specifically, FIG. 2A is a cross-sectional view taken along line 2A-2A in FIG. 1. The turbine engine 100 has an axial direction A (extending parallel to a longitudinal centerline axis 101, shown for reference in FIG. 2A), a radial direction R, and a circumferential direction C. The circumferential direction C extends in a direction rotating about the longitudinal centerline axis 101 (the axial direction A). In the embodiment depicted in FIG. 2A, the turbine engine 100 is a high bypass turbofan engine, including a fan section 102 and a turbo-engine 104 disposed downstream from the fan section 102.

The turbo-engine 104 depicted in FIG. 2A includes, in serial flow relationship, a compressor section 110, a combustion section 120, and a turbine section 130. The turbo-engine 104 is enclosed within an outer casing 106 that is tubular and defines a core inlet 141. In this embodiment, the core inlet 141 is annular. As schematically shown in FIG. 2A, the compressor section 110 includes a booster or a low-pressure (LP) compressor 112 followed downstream by a high-pressure (HP) compressor 114. The combustion section 120 is downstream of the compressor section 110. The turbine section 130 is downstream of the combustion section 120 and includes a high-pressure (HP) turbine 132 followed downstream by a low-pressure (LP) turbine 134. The turbo-engine 104 further includes a core air exhaust nozzle 143 (also referred to as a jet exhaust nozzle) that is downstream of the turbine section 130. The compressor section 110, the combustion section 120, and the turbine section 130 together define, at least in part, a core air flow path 140 extending from the core inlet 141 to the core air exhaust nozzle 143, and through which core air 145 flows. As will be discussed in more detail below, the turbo-engine 104 includes a high-pressure (HP) shaft 108 or a HP spool, and a low-pressure (LP) shaft 109. The HP shaft 108 drivingly connects the HP turbine 132 to the HP compressor 114. The HP turbine 132 and the HP compressor 114 rotate in unison through the HP shaft 108. The LP shaft 109 drivingly connects the LP turbine 134 to the LP compressor 112. The LP turbine 134 and the LP compressor 112 rotate in unison through the LP shaft 109.

Each of the LP compressor 112 and the HP compressor 114 may include a plurality of compressor stages. In each stage, a plurality of compressor blades 116 rotate relative to a corresponding plurality of static compressor vanes 118 (also called nozzles) to compress or to pressurize the core air 145 passing through the stage. In a single compressor stage, the plurality of compressor blades 116 can be provided in a ring, extending radially outwardly relative to the longitudinal centerline axis 101 from a blade platform to a blade tip (e.g., extend in the radial direction R). The compressor blades 116 may be a part of a compressor rotor that includes a disk and the plurality of compressor blades 116 extend radially from the disk. Other configurations of the compressor rotor may be used, including, for example, blisks where the disk and the compressor blades 116 are integrally formed with each other to be a single piece. The corresponding static compressor vanes 118 are positioned upstream of and adjacent to the rotating compressor blades 116. The compressor vanes 118 for a stage of the compressor can be mounted to a core casing 107 in a circumferential arrangement. The core casing 107 may define, at least in part, the core air flow path 140. Each compressor stage may be used to sequentially compress the core air 145 flowing through the core air flow path 140, generating compressed air 147. Any number of compressor blades 116, compressor vanes 118, and compressor stages may be used.

Each of the HP turbine 132 and the LP turbine 134 also may include a plurality of turbine stages. In each stage, a plurality of turbine blades 136 rotates relative to a corresponding plurality of static turbine vanes 138 (also called a nozzle) to extract energy from combustion gases 149 passing through the stage. The turbine blades 136 may be a part of a turbine rotor. Any configuration for a turbine rotor may be used, including, for example, a disk with the plurality of turbine blades 136 extending from the disk. The corresponding static turbine vanes 138 are positioned upstream of and adjacent to the rotating turbine blades 136. The turbine vanes 138 for a stage of the turbine can be mounted to the core casing 107 in a circumferential arrangement.

In the combustion section 120, fuel, received from a fuel system (not shown), is injected into a combustion chamber 124 of a combustor 122 by fuel nozzles 126. The fuel is mixed with the compressed air 147 from the compressor section 110 to form a fuel and air mixture, and combusted, generating combustion products (i.e., combustion gases 149). As will be discussed further below, adjusting a fuel metering unit (not shown) of the fuel system changes the volume of fuel provided to the combustion chamber 124 and, thus, changes the amount of propulsive thrust produced by the turbine engine 100 to propel the aircraft. The combustion gases 149 are discharged from the combustion chamber 124. These combustion gases may be directed into the turbine blades 136 of the HP turbine 132 and, then, the turbine blades 136 of the LP turbine 134, and the combustion gases 149 drive (rotate) the turbine blades 136 of the HP turbine 132 and the LP turbine 134. Any number of turbine blades 136, turbine vanes 138, and turbine stages may be used. After flowing through the turbine section 130, the combustion gases 149 are exhausted from the turbine engine 100 through the core air exhaust nozzle 143 to provide propulsive thrust.

The turbine engine 100 and, more specifically, the turbo-engine 104, further include one or more drive shafts. As noted above, the turbo-engine 104 includes the high-pressure (HP) shaft 108 drivingly connecting the HP turbine 132 to the HP compressor 114, and the low-pressure (LP) shaft 109 drivingly connecting the LP turbine 134 to the LP compressor 112. More specifically, the turbine rotors of the HP turbine 132 are connected to the HP shaft 108, and the compressor rotors of the HP compressor 114 are connected to the HP shaft 108. The combustion gases 149 are routed into the HP turbine 132 and expanded through the HP turbine 132 where a portion of thermal energy or kinetic energy from the combustion gases 149 is extracted via the one or more stages of the turbine blades 136 and turbine vanes 138 of the HP turbine 132. This causes the HP shaft 108 to rotate, supporting operation of the HP compressor 114 (self-sustaining cycle) and rotating the compressor rotors and, thus, the compressor blades 116 of the HP compressor 114 via the HP shaft 108. In this way, the combustion gases 149 do work on the HP turbine 132. The combustion gases 149 are then routed into the LP turbine 134 and expanded through the LP turbine 134. Here, a second portion of the thermal energy or the kinetic energy is extracted from the combustion gases 149 via one or more stages of the turbine blades 136 and the turbine vanes 138 of the LP turbine 134. This causes the LP shaft 109 to rotate, supporting operation of the LP compressor 112 (self-sustaining cycle), and rotating the compressor rotors and, thus, the compressor blades 116 of the LP compressor 112 via the LP shaft 109. In this way, the combustion gases 149 do work on the LP turbine 134. The HP shaft 108 and the LP shaft 109 are disposed coaxially about the longitudinal centerline axis 101. The HP shaft 108 has a diameter greater than that of the LP shaft 109, and the HP shaft 108 is located radially outward of the LP shaft 109. The HP shaft 108 and the LP shaft 109 are rotatable about the longitudinal centerline axis 101 and, as discussed above, are coupled to rotatable elements such as the compressor rotors and the turbine rotors.

The fan section 102 shown in FIG. 2A includes a fan 150 having a plurality of fan blades 152 coupled to a disk 154. The fan blades 152 and the disk 154 are rotatable, together, about the longitudinal centerline (axis) 101 by the LP shaft 109. The LP compressor 112 may also be directly driven by the LP shaft 109, as depicted in FIG. 2A. The disk 154 is covered by a fan hub 156 aerodynamically contoured to promote an airflow through the plurality of fan blades 152. Further, a nacelle 160 circumferentially surrounds the fan 150, and in the depicted embodiment, at least a portion of the turbo-engine 104. The nacelle 160 may also be referred to as an annular fan casing or an outer nacelle. The nacelle 160 is supported relative to the turbo-engine 104 by a plurality of outlet guide vanes 158 that are circumferentially spaced about the nacelle 160 and the turbo-engine 104. More specifically, the nacelle 160 is supported relative to the outer casing 106 by the plurality of outlet guide vanes 158. A downstream section 162 of the nacelle 160 extends over an outer portion of the turbo-engine 104 to define a bypass airflow passage 164 therebetween, and, more specifically, downstream section 162 extends over an outer portion of the outer casing 106 to define a bypass airflow passage 164 therebetween.

During operation of the turbine engine 100, a volume of air 166 enters the turbine engine 100 through an inlet of the nacelle 160 and/or the fan section 102 (referred to herein as a (an engine inlet 159). As the volume of air 166 passes across the fan blades 152, a first portion of air (a bypass air 168) is directed or routed into the bypass airflow passage 164, and a second portion of air (a core air 145) is directed or is routed into an upstream section of the core air flow path 140. More specifically, the core air 145 is directed or is routed into the core inlet 141. The ratio between the bypass air 168 and the core air 145 is commonly known as a bypass ratio. Simultaneously with the flow of the core air 145 through the core air flow path 140 (as discussed above), the bypass air 168 is routed through the bypass airflow passage 164 before being exhausted from a bypass air discharge nozzle 169 of the turbine engine 100, also providing propulsive thrust. The bypass air discharge nozzle 169 and the core air exhaust nozzle 143 are air exhaust nozzles of the turbine engine 100.

In the depicted embodiment, the bypass air discharge nozzle 169 and the core air exhaust nozzle 143 discharge into a common engine exhaust flow path 172. The combustion gases 149 and the bypass air 168 mix, forming engine exhaust 174. The engine exhaust 174 then flows through the engine exhaust flow path 172 from the turbine engine 100 to the engine exhaust nozzle 170. Other arrangements, however, may be used with the bypass air discharge nozzle 169 and the core air exhaust nozzle 143 being discharged separately from each other.

The rotating air 182 is provided by a rotating air source 180. The rotating air source 180 can be any source of high-pressure gas, such as stored compressed gas or gas generated through a chemical reaction. In the depicted embodiment, however, and as noted above, the turbine engine 100 provides the rotating air 182 to drive the lift fan assemblies 200 in the depicted embodiment. The rotating air source 180 and the rotating air 182 can be various different sources of air within the turbine engine 100. The rotating air 182 can be at least a portion of the combustion gases 149, which is referred to herein as a combustion gas rotating air portion 184. The combustion gas rotating air portion 184 is drawn from a portion of the turbine engine 100 downstream of the combustion chamber 124 relative to the flow of the combustion gases 149. For example, the combustion gas rotating air portion 184 can be drawn from a portion of the core air flow path 140 downstream of the HP turbine 132, such as downstream of the LP turbine 134. The combustion gas rotating air portion 184 can be drawn from a position downstream of the turbine section 130. Although depicted in FIG. 2A as being drawn from the core air flow path 140, the combustion gas rotating air portion 184 can also be drawn from the engine exhaust flow path 172 and be engine exhaust 174.

A rotating air flow control valve 186 can be positioned in the rotating air flow path 202 (FIG. 1) between the lift fan assembly 200 and the turbine engine 100 to control the flow of the rotating air 182 from the turbine engine 100 to the lift fan assembly 200. The rotating air flow control valve 186 together with the speed of the turbine engine 100 can be used to control the speed and the amount of lift produced by the lift fan assembly 200.

The turbine engine 100 can also include a controller 190. In FIG. 2A, the controller 190 is depicted as an engine controller, such as a Full Authority Digital Engine Control (FADEC). The controller 190 is configured to operate various aspects of the turbine engine 100, including the rotating air flow control valve 186. In this embodiment, the controller 190 is a computing device having one or more processors 192 and one or more memories 194. The processor 192 can be any processing device, including, but not limited to, a microprocessor, a microcontroller, an integrated circuit, a logic device, a programmable logic controller (PLC), an application-specific integrated circuit (ASIC), and/or a Field Programmable Gate Array (FPGA). The memory 194 can include one or more computer-readable media, including, but not limited to, non-transitory computer-readable media, a computer-readable non-volatile medium (e.g., a flash memory), a RAM, a ROM, hard drives, flash drives, and/or other memory devices.

The memory 194 can store information accessible by the processor 192, including computer-readable instructions that can be executed by the processor 192. The instructions can be any set of instructions or a sequence of instructions that, when executed by the processor 192, causes the processor 192 and the controller 190 to perform operations. In some embodiments, the instructions can be executed by the processor 192 to cause the processor 192 to complete any of the operations and functions for which the controller 190 is configured, as will be described further below. The instructions can be software written in any programming language, or can be implemented in hardware. Additionally, and/or alternatively, the instructions can be executed in logically and/or virtually separate threads on the processor 192. The memory 194 can further store data that can be accessed by the processor 192.

The technology discussed herein makes reference to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between components and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

FIG. 2B is a schematic, cross-sectional view of another turbine engine 100A that may be used on the aircraft 10. As noted above, the rotating air source 180 may be various different air sources of the turbine engine. FIG. 2B depicts the rotating air 182 being drawn from another air source of the turbine engine 100A. The rotating air 182 can be at least a portion of the compressed air 147, which is referred to herein as a compressed air rotating air portion 188. The compressed air rotating air portion 188 is drawn from the compressor section 110 or downstream thereof, such as downstream of the HP compressor 114 and upstream of the combustion chamber 124 relative to the flow of the compressed air 147. For example, the combustion gas rotating air portion 184 can be drawn from one of the stages of the HP compressor 114. The turbine engine 100A depicted in FIG. 2B is otherwise the same as the turbine engine 100 depicted in FIG. 2A and the description of FIG. 2A applies to the turbine engine 100A shown in FIG. 2B.

The turbine engines 100 shown in FIGS. 2A and 2B and discussed herein (e.g., a turbofan engine) is provided by way of example only. In other embodiments, any other engine may be utilized with aspects of the present disclosure. For example, in other embodiments, the engine may be any other gas turbine engine, such as a turboshaft engine, a turboprop engine, a turbojet engine, an unducted single fan engine, and the like. In such a manner, in other embodiments, the gas turbine engine may have other configurations, such as other numbers or arrangements of shafts, compressors, turbines, fans, etc. Further, although the turbine engine 100 is shown as a direct drive, fixed-pitch turbofan engine, in other embodiments, the turbine engine 100 may be a geared turbine engine (e.g., including a gearbox between the fan 150 and a shaft driving the fan, such as the LP shaft 109), may be a variable pitch turbine engine (i.e., including a fan 150 having a plurality of fan blades 152 rotatable about their respective pitch axes), etc. Further, still, in alternative embodiments, aspects of the present disclosure may be incorporated into, or otherwise utilized with, any other type of engine, such as a reciprocating engine.

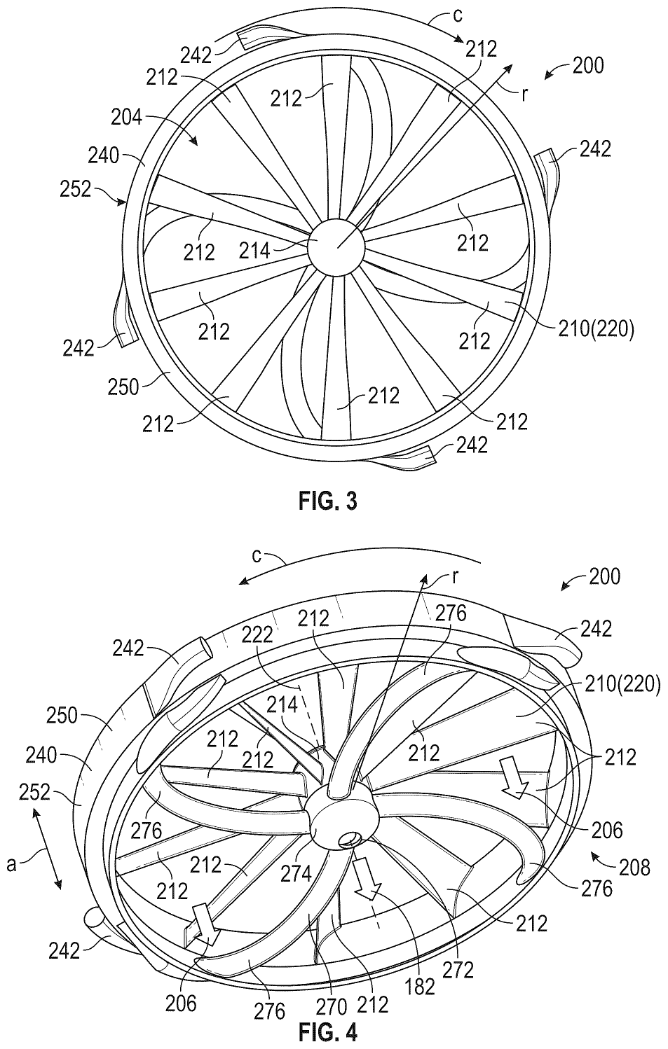

FIG. 3 is a top view of one of the lift fan assemblies 200 of the aircraft 10 shown in FIG. 1. FIG. 3 shows the inlet side 204 of the lift fan assembly 200. FIG. 4 is a schematic view of the lift fan assembly 200 shown in FIG. 3, showing the outlet side 208 of the lift fan assembly 200. The lift fan assembly 200 includes a fan 210 that is part of a rotor 220 of the lift fan assembly 200. The fan 210 includes a plurality of fan blades 212 rotatable about a rotational axis 222 in a circumferential direction c. The plurality of fan blades 212 extends outward in a radial direction r from the rotational axis 222, and, more specifically, the fan 210 includes a hub 214 and the fan blades 212 are connected to the hub 214 to extend outwardly therefrom. The fan 210 also includes an axial direction a, which is a direction parallel to the rotational axis 222. Lower case reference characters are used to refer to the circumferential direction c, the radial direction r, and the axial direction a of the fan 210 and the lift fan assembly 200 to distinguish from the directions of the turbine engine 100 discussed above, which use upper case reference characters.

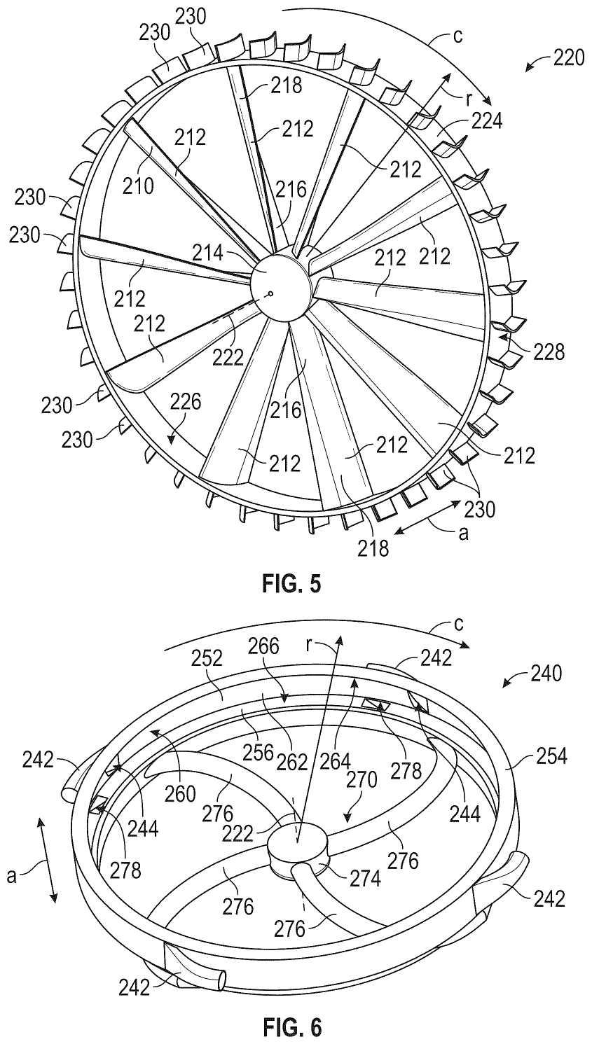

FIG. 5 is a schematic view of the rotor 220. As noted above, the fan blades 212 extend outward from the hub 214. Each of the fan blades 212 includes a root end 216 proximate to the hub 214 and a tip 218. The tip 218 is the end of the fan blades 212 distal from the hub 214. The rotor 220 includes an outer band 224 that is connected to the tips 218 of the fan blades 212. In the depicted embodiment, the outer band 224 is directly attached to at least some of the tips 218 of the fan blades 212. Although the outer band 224 can be attached to only a portion of the fan blades 212, the outer band 224 is attached to the tips 218 of each of the fan blades 212 in the embodiment depicted in FIG. 5. The outer band 224 is annular, including an inner surface 226. The fan 210 is formed radially inward from the outer band 224, and the outer band 224 is radially outward of the fan 210. More specifically, the outer band 224 is radially outward of the fan blades 212. The outer band 224 may define, at least in part, a flow path for the air flowing through the fan 210.

The rotor 220 also includes a plurality of outer airfoils 230 located outward in the radial direction r from the plurality of fan blades 212. For clarity, only a portion of the outer airfoils 230 is labeled in FIG. 5 and other figures discussed herein. The outer airfoils 230 are rotatable about the rotational axis r in the circumferential direction c. As will be discussed further below, the rotating air 182 (FIG. 2A) is directed toward the outer airfoils 230 and the rotating air 182 impinges upon the outer airfoils 230 to rotate the outer airfoils 230 about the rotational axis r in the circumferential direction c. The outer airfoils 230 are connected to the fan blades 212 to rotate the fan blades 212. In the embodiment depicted in FIG. 5, the outer band 224 includes an outer surface 228, and the outer airfoils 230 are attached, such as directly attached, to the outer surface 228 of the outer band 224. The outer airfoils 230 rotate the fan blades 212.

Referring back to FIGS. 3 and 4, the lift fan assembly 200 includes a stator 240. The stator 240 includes an outer airfoil case 250 that defines, at least in part, an outer airfoil passage 260 (FIG. 6) in which the outer airfoils 230 are located and rotate. In the embodiment depicted in FIG. 4, the outer band 224 also defines the outer airfoil passage 260. The lift fan assembly 200 includes one or more inlet nozzles 242 that are fluidly coupled to the rotating air source 180 (FIG. 2A) via the rotating air flow path 202 (FIG. 1) to provide the rotating air 182 (FIG. 2A) to the rotor 220 and to rotate the fan 210. The inlet nozzles 242 are part of, or otherwise connected to, the stator 240. More specifically, in the embodiment depicted in FIG. 4, the inlet nozzles 242 are attached to an outer wall 252 of the outer airfoil case 250 to direct the rotating air 182 into the outer airfoil passage 260 to impinge on the outer airfoils 230.

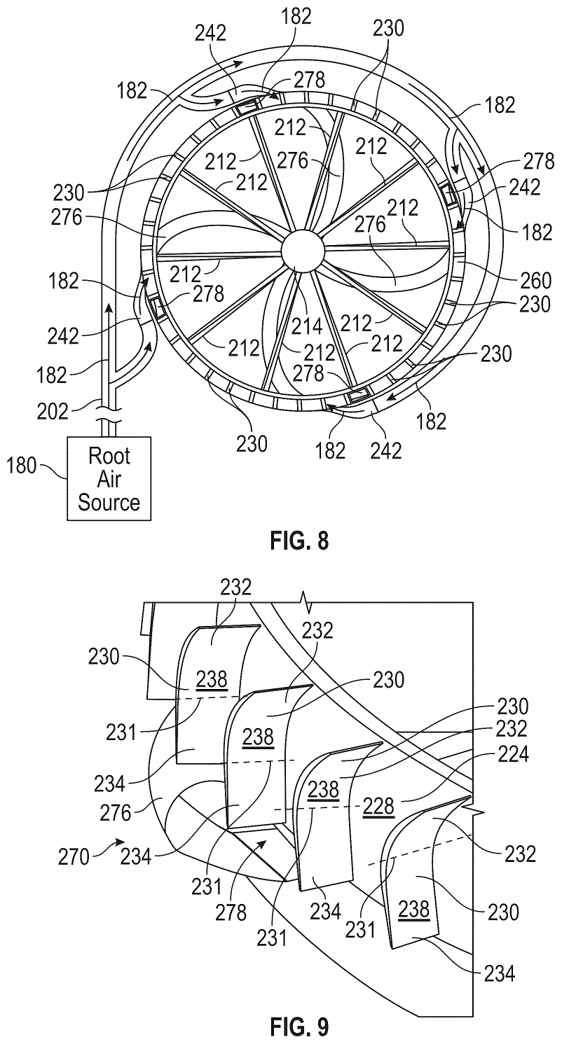

FIG. 6 is a schematic view of the stator 240 and, with the rotor 220 removed, the outer airfoil passage 260 is visible in FIG. 6. The outer airfoil case 250 is U-shaped in the depicted embodiment with an outer wall 252, an upper wall 254, and a lower wall 256 defining the outer airfoil passage 260 with the outer band 224. The outer airfoil passage 260 includes a radially outer surface 262 formed on the outer wall 252, an upper surface 264 formed on the outer wall 252, and a lower surface 266 formed on the lower wall 256. The inlet nozzles 242 project through the outer wall 252 and include inlet nozzle openings 244 formed in the radially outer surface 262 to allow the rotating air 182 (FIG. 8) to flow therethrough.

The lift fan assembly 200 of the depicted embodiment includes a plurality of inlet nozzles 242. The inlet nozzles 242 are circumferentially spaced apart from each other and can be uniformly spaced apart from each other. For example, when two inlet nozzles 242 are used, the inlet nozzles 242 can be spaced apart from each other by one hundred eighty degrees (180 degrees) in the circumferential direction c, or when three inlet nozzles 242 are used, the inlet nozzles 242 can be spaced apart from each other by one hundred twenty degrees (120 degrees) in the circumferential direction c. In the depicted embodiment, four inlet nozzles 242 are shown and the inlet nozzles 242 are spaced apart from each other by ninety degrees (90 degrees) in the circumferential direction c.

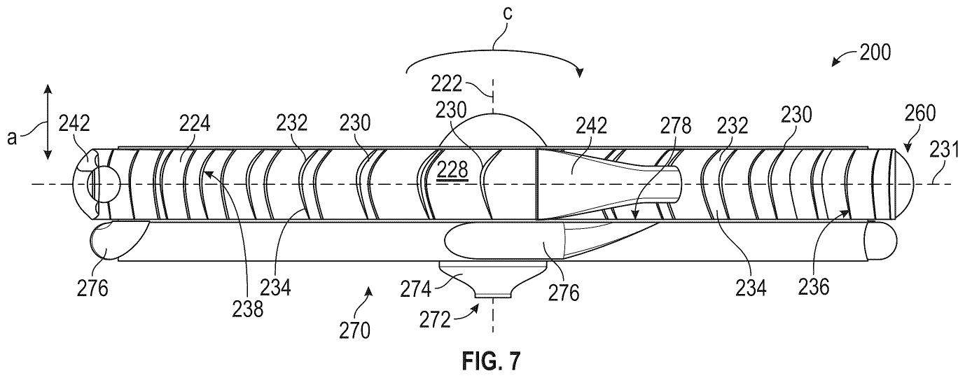

FIG. 7 is a side view of the lift fan assembly 200 with the outer wall 252 removed to show the outer airfoils 230 in the outer airfoil passage 260. The outer airfoils 230 include a centerline 231 in the axial direction a. The centerline 231 defines an upper portion 232 of each of the outer airfoils 230 and a lower portion 234 of each of the outer airfoils 230. The outer airfoils 230 are shaped based on the airflow direction of the rotating air 182, and, in the depicted embodiment, the outer airfoils 230 are cambered. Each outer airfoil 230 also includes a leading surface 236 and a trailing surface 238 relative to the direction of rotation of the outer airfoils 230. In the depicted embodiment, the trailing surface 238 has a concave shape, and the leading surface 236 also has a convex shape.

FIG. 8 is a schematic view of the lift fan assembly 200 taken along the centerline 231 in FIG. 7. Only a portion of the outer airfoils 230 is shown in FIG. 8 for clarity. The rotating air 182 is received from the rotating air source 180 and provided to the inlet nozzles 242 by the rotating air flow path 202. The inlet nozzles 242 are positioned and oriented to direct the rotating air 182 in a rotating airflow direction and to inject the rotating air 182 into the outer airfoil passage 260. The rotating airflow direction is transverse to the radial direction r, such as a radially inward direction. The rotating airflow direction also has a component in a direction tangential to the circumferential direction c. With such a rotating airflow direction, the rotating air 182 impinges on the outer airfoils 230 to rotate the outer airfoils 230. More specifically, the rotating air 182 impinges on the trailing surface 238 of the outer airfoils 230 to rotate the outer airfoils 230. With the outer airfoils 230 connected to the fan 210, the outer airfoils 230 rotate the fan 210 and the fan blades 212.

Referring back to FIG. 4, when the rotating air 182 is provided to the inlet nozzles 242, the rotating air 182 rotates the rotor 220 including the fan 210, as previously discussed. The fan 210 draws air from the inlet side 204 (FIG. 1) of the fan 210 and accelerates the air, discharging the accelerated air from the fan 210 as the column of propulsor discharge air 206 to produce lift for the aircraft 10.

While the rotating air 182 can be discharged from the lift fan assembly 200, such as by being directed downward from the outer airfoil case 250, the lift fan assembly 200 depicted in FIG. 4 includes a discharge assembly 270. The discharge assembly 270 collects the rotating air 182 after the rotating air 182 rotates the outer airfoils 230 and directs the rotating air 182 to a rotating air discharge nozzle 272. The rotating air discharge nozzle 272 discharges the rotating air 182 and, in the depicted embodiment, the rotating air discharge nozzle 272 discharges the rotating air 182 into the column of propulsor discharge air 206. As noted above, the rotating air source 180 (FIG. 2A) can be from the turbine engine 100, such as combustion gases 149 (FIG. 2A). The combustion gases 149 are relatively hot, and, by discharging the hot rotating air 182 into the column of propulsor discharge air 206, the rotating air 182 the column of propulsor discharge air 206 shields the surrounding environment and personnel from the higher temperature rotating air 182. In some embodiments, the rotating air 182 can be discharged into the column of propulsor discharge air 206 in such a way, including those discussed herein, that the rotating air 182 mixes with the column of propulsor discharge air 206 and is cooled by the column of propulsor discharge air 206. Cooling the rotating air 182 discharged from the lift fan assembly 200 or shielding the rotating air 182 reduces the amount of hot air discharged around the aircraft 10, improving safety for persons and components in and around the aircraft 10. In addition, hot air flow, such as the rotating air 182, produces more noise than cooler air, and mixing the rotating air 182 with the column of propulsor discharge air 206 also attenuates the acoustic energy of the rotating air 182, reducing the total sound produced by the lift fan assembly 200.

In the embodiment depicted in FIG. 4, the rotating air discharge nozzle 272 is formed on a discharge plenum 274. The discharge plenum 274 and the rotating air discharge nozzle 272 are located on a downstream side of the hub 214 relative to the column of propulsor discharge air 206. More specifically, the rotating air discharge nozzle 272 is positioned along the rotational axis 222 to discharge the rotating air 182 into the center of the column of propulsor discharge air 206. The discharge plenum 274 is fluidly connected to the outer airfoil passage 260 of the outer airfoil case 250 by one or more discharge conduits 276. As noted above, the rotating air 182 is flowing through the outer airfoil passage 260 in the circumferential direction c. To promote the smooth flow of rotating air 182 from the outer airfoil passage 260 to the discharge plenum 274, the discharge conduit 276 has a curved shape in the circumferential direction c. The discharge conduit 276 is also depicted in FIG. 8. The curved shape can be an arcuate shape.

Referring to FIG. 6 (and as also can be seen in FIG. 8), each discharge conduit 276 includes a corresponding discharge port 278, which, in the depicted embodiment, is an opening formed in the lower surface 266 of the lower wall 256. The lift fan assembly 200 of the depicted embodiment includes a plurality of the discharge conduits 276 and the discharge ports 278. The discharge ports 278 are circumferentially spaced apart from each other and can be uniformly spaced apart from each other. For example, when two discharge ports 278 are used, the discharge ports 278 can be spaced apart from each other by one hundred eighty degrees (180 degrees) in the circumferential direction c, or when three discharge ports 278 are used, the discharge ports 278 can be spaced apart from each other by one hundred twenty degrees (120 degrees) in the circumferential direction c. In the depicted embodiment, four discharge ports 278 and four discharge conduits 276 are shown, and the discharge ports 278 are spaced apart from each other by ninety degrees (90 degrees) in the circumferential direction c. This positioning and spacing is illustrative and other numbers and positioning of the discharge ports 278 can be used and tailored to the application as needed with respect to number of discharge ports 278 and spacing and positioning thereof. The discharge ports 278 are positioned within the outer airfoil passage 260 to allow the rotating air 182 (FIG. 8) to flow in the circumferential direction c. The rotating air 182 injected by a first inlet nozzle 242 impinges upon the outer airfoils 230 (FIG. 8) and flows in the circumferential direction c. A first discharge port 278 is positioned proximate to a second inlet nozzle 242 on the upstream side thereof to maximize the work the outer airfoils 230 can extract from the rotating air 182 before being directed to the discharge port 278. This first discharge port 278 receives the rotating air 182 injected by the first inlet nozzle 242 before additional rotating air 182 is injected by the second inlet nozzle 242.

FIG. 9 is a detail view showing a portion of the outer band 224 with outer airfoils 230 thereon and a portion of the discharge assembly 270. The discharge ports 278 are located under the outer airfoils 230, and the outer airfoils 230 are shaped to direct the rotating air 182 towards the discharge ports 278 after the rotating air 182 impinges on the outer airfoils 230. More specifically, the trailing surfaces 238 are shaped to direct the rotating air 182 towards the discharge ports 278 after the rotating air 182 impinges on the trailing surfaces 238 of the outer airfoils 230. As noted above and as can also be seen in FIG. 7, each outer airfoil 230 includes a centerline 231 defining the upper portion 232 and the lower portion 234. The upper portion 232 can have a greater degree of curvature than the lower portion 234, having a greater circumferential extent in the direction opposite the circumferential direction c. The lower portion 234, in contrast, is more vertical (oriented more in the axial direction a) than the upper portion 232. With this shape, the outer airfoils 230 direct the rotating air 182 toward the discharge ports 278.

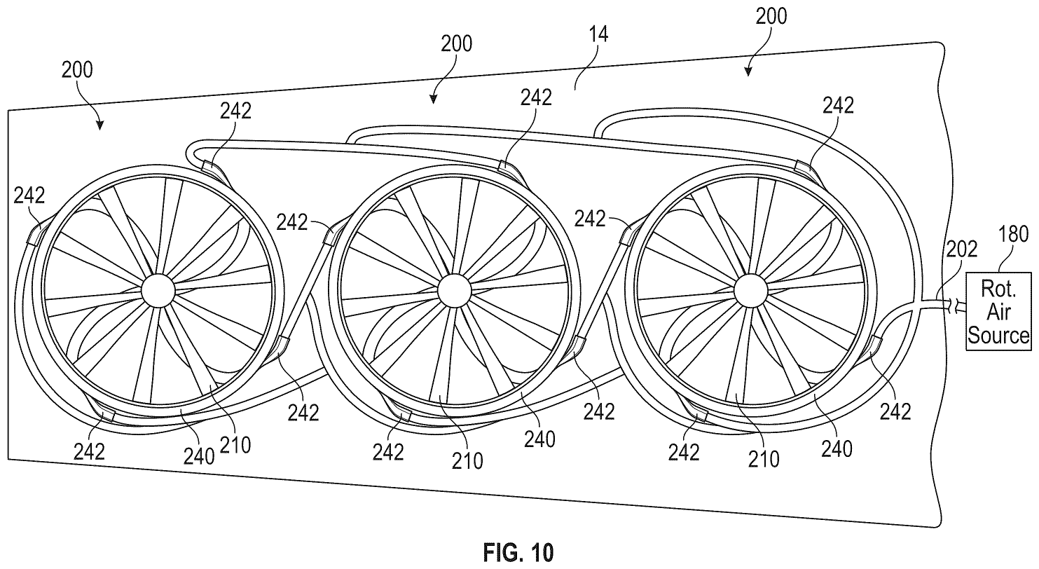

FIG. 10 shows a configuration for a plurality of lift fan assemblies 200 formed in a portion of the aircraft 10, such as one of the wings 14. Within the lift fan assembly 200, each of the inlet nozzles 242 can be fluidly connected to the rotating air source 180 in parallel with each other relative to the flow of rotating air 182. Likewise, when a plurality of lift fan assemblies 200 are used, each lift fan assembly 200 can also be connected to the rotating air source 180 in parallel with each other relative to the flow of rotating air 182. FIG. 10 shows the plurality of lift fan assemblies 200 connected to the rotating air source 180 in this manner.

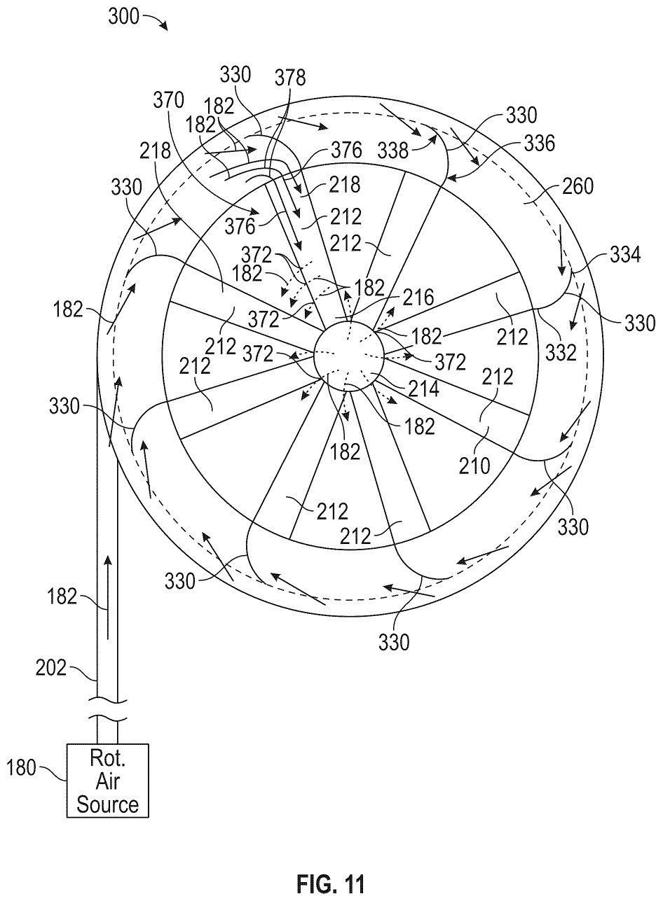

FIG. 11 is a schematic view of another lift fan assembly 300. The lift fan assembly 300 shown in FIG. 11 is similar to the lift fan assembly 200 shown in FIG. 3 and the discussion above applies here. The lift fan assembly 300 shown in FIG. 11 has a plurality of outer airfoils 330 that are connected to the fan blades 212 to rotate the fan blades 212, similarly to the outer airfoils 230 discussed above. The outer airfoils 330 depicted in FIG. 11 are similar to the outer airfoils 230 discussed above, and that discussion generally applies here, but the outer airfoils 330 depicted in FIG. 11 have a different shape. While the outer airfoils 330 depicted in FIG. 11 are cambered, each outer airfoil 330 is shaped to redirect the rotating air 182 radially inward. Each outer airfoil 330 includes an inner portion 332 and an outer portion 334 relative to the radial direction r. The inner portion 332 is connected to and, in the depicted embodiment, directly attached to the outer band 224. Each outer airfoil 330 also includes a leading surface 336 and a trailing surface 338 relative to the direction of rotation of the outer airfoils 330. The outer airfoils 330 are shaped such that the outer portion 334 trails the inner portion 332 relative to the direction of rotation of the outer airfoils 330. Each outer airfoil 330 is curved radially inward to direct the rotating air 182 radially inward.

The lift fan assembly 300 shown in FIG. 11 also has a different discharge assembly 370. The outer airfoil 330 are shaped and connected to the fan 210 to direct the rotating air 182 into the fan 210 and discharge the rotating air 182 through the fan 210. The discharge assembly 370 includes a plurality of discharge ports 378. These ports 378 are formed in the fan blades 212, and, more specifically, the ports 378 are formed in the tip 218 of each of the fan blades 212. The rotating air 182 flows into the discharge ports 378 and through discharge conduits 376 formed in the fan blades 212 before being ejected out rotating air discharge openings 372. The rotating air discharge openings 372 can be formed in the hub 214, in the fan blades 212, or both. When the rotating air discharge openings 372 are formed in the fan blades 212, the rotating air discharge openings 372 can be formed in a trailing portion of each of fan blades 212, such as a trailing edge of the fan blades 212, and the discharged air can be directed in a direction opposite the rotation direction of the fan blades 212. When the rotating air 182 is discharged from the hub 214, the rotating air 182 can be discharged into the column of propulsor discharge air 206 in a manner similar to that discussed above.

Embodiments discussed herein provide lift fan assemblies 200, 300 that can be driven by a turbine engine 100 of an aircraft 10. The lift fan assemblies 200, 300 include features for efficient operation, such as rotating airfoil direction discussed above. In addition to these features that improve the efficiency of operation, the discharge assemblies 270, 370 that provide for a mixing of the hot exhaust air used as the rotating air 182, lowering the temperature of the exhaust and attenuating the acoustic energy of the exhaust.

Further aspects of the present disclosure are provided by the subject matter of the following clauses.

A lift fan assembly for an aircraft includes a rotor and an inlet nozzle. The rotor includes a fan and a plurality of outer airfoils. The fan has a plurality of fan blades rotatable about a rotational axis in a circumferential direction. The plurality of fan blades extend outward in a radial direction from the rotational axis. The plurality of outer airfoils is located outward in the radial direction from the plurality of fan blades. The plurality of outer airfoils is rotatable about the rotational axis in the circumferential direction and is connected to the plurality of fan blades to rotate the plurality of fan blades. The inlet nozzle is positioned and oriented to direct rotating air in a rotating airflow direction to impinge on outer airfoils of the plurality of outer airfoils and to rotate the plurality of outer airfoils. The rotating airflow direction is transverse to the radial direction and has a component in a direction tangential to the circumferential direction.

A lift fan assembly for an aircraft includes a rotor, an inlet nozzle, and a discharge assembly. The rotor includes a fan and a plurality of outer airfoils. The fan has a plurality of fan blades rotatable about a rotational axis in a circumferential direction to generate a column of propulsor discharge air. The plurality of fan blades extends outward in a radial direction from the rotational axis. The plurality of outer airfoils is located outward in the radial direction from the plurality of fan blades. The plurality of outer airfoils is rotatable about the rotational axis in the circumferential direction and is connected to the plurality of fan blades to rotate the plurality of fan blades. The inlet nozzle is positioned and oriented to direct rotating air in a rotating airflow direction to impinge on outer airfoils of the plurality of outer airfoils and to rotate the plurality of outer airfoils. The discharge assembly includes a discharge port, a discharge nozzle, and a discharge conduit. The discharge port is positioned to collect the rotating air after the rotating air has impinged on the outer airfoils of the plurality of outer airfoils. The discharge nozzle is positioned to discharge the rotating air into the column of propulsor discharge air. The discharge conduit fluidly connects the discharge port with the discharge nozzle.

The lift fan assembly of the preceding clause, wherein the rotating airflow direction is transverse to the radial direction and has a component in a direction tangential to the circumferential direction.

The lift fan assembly of any preceding clause, wherein each airfoil of the plurality of outer airfoils has a concave shape.

The lift fan assembly of any preceding clause, wherein each outer airfoil of the plurality of outer airfoils has a camber and a centerline in an axial direction parallel to the rotational axis, the camber of the outer airfoil being asymmetrical about the centerline.

The lift fan assembly of the preceding clause, wherein the centerline defines an upper portion of the outer airfoil and a lower portion of the outer airfoil, one of the upper portion and the lower portion having a greater degree of curvature than the other one of the upper portion and the lower portion.

The lift fan assembly of any preceding clause, wherein the inlet nozzle is one nozzle of a plurality of inlet nozzles, each inlet nozzle of the plurality of inlet nozzles being positioned and oriented to direct the rotating air in the rotating airflow direction to impinge on outer airfoils of the plurality of outer airfoils and to rotate the plurality of outer airfoils.

The lift fan assembly of the preceding clause, wherein the inlet nozzles of the plurality of inlet nozzles are circumferentially spaced apart from each other.

The lift fan assembly of any preceding clause wherein the plurality of inlet nozzles is fluidly connected to a rotating air source in parallel.

The lift fan assembly of any preceding clause, further comprising a discharge assembly. The discharge assembly includes a discharge port, a discharge nozzle, and a discharge conduit fluidly connecting the discharge port with the discharge nozzle. The discharge port is positioned to collect the rotating air after the rotating air has impinged on the outer airfoils of the plurality of outer airfoils. The plurality of fan blades is rotatable about the rotational axis to generate a column of propulsor discharge air, and the discharge nozzle is positioned to discharge the rotating air into the column of propulsor discharge air.

The lift fan assembly of the preceding clause, wherein the fan further includes a hub, the plurality of fan blades extending outward in the radial direction from the hub, and the discharge nozzle being positioned on a downstream side of the hub relative to the column of propulsor discharge air.

The lift fan assembly of any preceding clause, wherein the discharge nozzle is positioned along the rotational axis.

The lift fan assembly of any preceding clause, wherein the discharge conduit is a tube having a curved shape in the circumferential direction.

The lift fan assembly of any preceding clause, wherein each outer airfoil of the plurality of outer airfoils is shaped to direct the rotating air radially inward.

The lift fan assembly of the preceding clause, further comprising a discharge assembly. The discharge assembly includes a discharge port and a discharge nozzle. The discharge port positioned to collect the rotating air after the rotating air has impinged on the outer airfoils of the plurality of outer airfoils. The plurality of fan blades is rotatable about the rotational axis to generate a column of propulsor discharge air, and the discharge nozzle is positioned to discharge the rotating air into the column of propulsor discharge air. The discharge nozzle is fluidly connected to the discharge port through the plurality of fan blades.

The lift fan assembly of the preceding clause, wherein the discharge nozzle is one discharge nozzle of a plurality of discharge nozzles and the plurality of discharge nozzles is formed in the plurality of fan blades.

The lift fan assembly of the preceding clause, wherein each fan blade includes a leading portion and a trailing portion, the trailing portion of each fan blade including the discharge nozzles of the plurality of discharge nozzles formed in a respective fan blade.

An aircraft including the lift fan assembly of any preceding clause and a turbine engine generating the rotating air for the lift fan assembly.

The aircraft of the preceding clause, wherein the turbine engine includes a combustor located in a core air flow path to receive compressed air and fluidly coupled to a fuel source to receive fuel, the fuel being injected into the combustor to mix with the compressed air to generate a fuel and air mixture, the fuel and air mixture being combusted in the combustor to generate combustion gases, the rotating air being at least a portion of the combustion gases.

The aircraft of any preceding clause, wherein the turbine engine includes a combustor, an engine shaft, a turbine, and a compressor. The combustor located in a core air flow path to receive compressed air and fluidly coupled to a fuel source to receive fuel. The fuel is injected into the combustor to mix with the compressed air to generate a fuel and air mixture, and the fuel and air mixture is combusted in the combustor to generate combustion gases. The turbine is located downstream of the combustor to receive the combustion gases. The turbine is drivingly coupled to the engine shaft and rotated in response to receiving the combustion gases. The compressor is positioned in the core air flow path upstream of the combustor and driven by the engine shaft to compress core air flowing through the core air flow path and to generate the compressed air. The rotating air is a portion of the compressed air.

The aircraft of any preceding clause, wherein the plurality of fan blades is rotatable about the rotational axis to generate a column of propulsor discharge air, the lift fan assembly being oriented on the aircraft such that the column of propulsor discharge air produces lift.

The aircraft of any preceding clause, wherein the lift fan assembly is one lift fan assembly of a plurality of lift fan assemblies, each lift fan assembly of the plurality of lift fan assemblies include a fan and an inlet nozzle. The fan includes a plurality of fan blades and a plurality of outer airfoils. The plurality of fan blades is rotatable about a rotational axis in a circumferential direction. The plurality of fan blades extend outward in a radial direction from the rotational axis. The plurality of outer airfoils is located outward in the radial direction from the plurality of fan blades. The plurality of outer airfoils is rotatable about the rotational axis in the circumferential direction and is connected to the plurality of fan blades to rotate the plurality of fan blades. The inlet nozzle is positioned and oriented to direct rotating air in a rotating airflow direction to impinge on outer airfoils of the plurality of outer airfoils and to rotate the plurality of outer airfoils. The rotating airflow direction is transverse to the radial direction and having a component in a direction tangential to the circumferential direction.

The aircraft of the preceding clause, wherein the inlet nozzles of the plurality of lift fan assemblies are fluidly connected to a rotating air source in parallel with each other relative to the rotating air.

The aircraft of any preceding clause, further comprising a rotating air flow control valve positioned in a rotating air flow path between the lift fan assembly and the turbine engine to control the flow of the rotating air from the turbine engine to the lift fan assembly.

Although the foregoing description is directed to the preferred embodiments, other variations and modifications will be apparent to those skilled in the art, and may be made without departing from the disclosure. Moreover, features described in connection with one embodiment may be used in conjunction with other embodiments, even if not explicitly stated above.

1. A lift fan assembly for an aircraft, the lift fan assembly comprising:
a rotor comprising:
a fan including plurality of fan blades rotatable about a rotational axis in a circumferential direction, the plurality of fan blades extending outward in a radial direction from the rotational axis, each of the plurality of fan blades having a fan blade tip;
an outer band including an inner surface and an outer surface, the outer surface located radially outward of the inner surface, the outer band circumscribing the plurality of fan blades, wherein the fan blade tips are connected to the inner surface of the outer band;
a plurality of outer airfoils extending radially outward from the outer surface of the outer band, wherein the plurality of outer airfoils are configured to rotate about the rotational axis in the circumferential direction; and
an inlet nozzle positioned and oriented to direct air as rotating air in a rotating airflow direction, the rotating airflow direction being transverse to the radial direction and having a component in a direction tangential to the circumferential direction, wherein the inlet nozzle is configured to inject the rotating air to impinge on outer airfoils of the plurality of outer airfoils and to rotate the plurality of outer airfoils, thereby rotating the plurality of fan blades.

2. The lift fan assembly of claim 1, wherein each outer airfoil of the plurality of outer airfoils has a camber and a centerline in a radial direction extending radially outwards from the rotation axis, the camber of each outer airfoil of the plurality of airfoils being asymmetrical about the centerline.

3. The lift fan assembly of claim 2, wherein each outer airfoil of the plurality of airfoils has a leading edge, a trailing edge, an upper portion extending from the leading edge, and a lower portion extending from the trailing edge, the upper portion being contiguous with the lower portion, wherein one of the upper portion and the lower portion has a greater degree of curvature than the other one of the upper portion and the lower portion.

4. The lift fan assembly of claim 1, wherein the inlet nozzle is one nozzle of a plurality of inlet nozzles, each inlet nozzle of the plurality of inlet nozzles being positioned and oriented to direct the rotating air in the rotating airflow direction to impinge on outer airfoils of the plurality of outer airfoils and to rotate the plurality of outer airfoils.

5. The lift fan assembly of claim 4, wherein the inlet nozzles of the plurality of inlet nozzles are circumferentially spaced apart from each other.

6. The lift fan assembly of claim 4, wherein the inlet nozzles of the plurality of inlet nozzles are fluidly connected in parallel to a rotating air source.

7. The lift fan assembly of claim 1, further comprising a discharge assembly including:
a discharge port positioned to collect the rotating air after the rotating air has impinged on the outer airfoils of the plurality of outer airfoils;
a discharge nozzle configured to receive the rotating air from the discharge port and discharge the rotating air into a column of propulsor discharge air generated by the plurality of fan blades rotating about the rotational axis; and
a discharge conduit fluidly connecting the discharge port with the discharge nozzle, the discharge conduit configured to direct the rotating air from the discharge port to the discharge nozzle.

8. The lift fan assembly of claim 7, wherein the fan further includes a hub, the plurality of fan blades extending outward in the radial direction from the hub, and the discharge nozzle being positioned on a downstream side of the hub relative to the column of propulsor discharge air.

9. The lift fan assembly of claim 7, wherein the discharge nozzle is positioned along the rotational axis.

10. The lift fan assembly of claim 7, wherein the discharge conduit is a tube having a curved shape in the circumferential direction.

11. The lift fan assembly of claim 1, wherein each outer airfoil of the plurality of outer airfoils is shaped to direct the rotating air radially inward.

12. The lift fan assembly of claim 11, further comprising a discharge assembly including:
a discharge port positioned to collect the rotating air after the rotating air has impinged on the outer airfoils of the plurality of outer airfoils; and
a discharge nozzle, wherein the plurality of fan blades is rotatable about the rotational axis to generate a column of propulsor discharge air, and the discharge nozzle is positioned to discharge the rotating air into the column of propulsor discharge air, wherein the discharge nozzle is fluidly connected to the discharge port through the plurality of fan blades.

13. The lift fan assembly of claim 12, wherein the discharge nozzle is one discharge nozzle of a plurality of discharge nozzles and the plurality of discharge nozzles is formed in the plurality of fan blades.

14. The lift fan assembly of claim 13, wherein each fan blade includes a leading portion and a trailing portion, the trailing portion of each fan blade including the discharge nozzles of the plurality of discharge nozzles formed in a respective fan blade.

15. An aircraft comprising:
a fuselage;
at least one wing extending from the fuselage;
the lift fan assembly of claim 1 mounted to the aircraft; and
a turbine engine mounted to the aircraft, the turbine engine generating the rotating air for the lift fan assembly.

16. The aircraft of claim 15, wherein the turbine engine comprises a combustor located in a core air flow path to receive compressed air and fluidly coupled to a fuel source to receive fuel, the fuel being injected into the combustor to mix with the compressed air to generate a fuel and air mixture, the fuel and air mixture being combusted in the combustor to generate combustion gases, the rotating air being at least a portion of the combustion gases.

17. The aircraft of claim 15, wherein the turbine engine comprises:
a combustor located in a core air flow path to receive compressed air and fluidly coupled to a fuel source to receive fuel, the fuel being injected into the combustor to mix with the compressed air to generate a fuel and air mixture, the fuel and air mixture being combusted in the combustor to generate combustion gases;
an engine shaft;
a turbine located downstream of the combustor to receive the combustion gases, the turbine drivingly coupled to the engine shaft and rotated in response to receiving the combustion gases; and a compressor positioned in the core air flow path upstream of the combustor and driven by the engine shaft to compress core air flowing through the core air flow path and to generate the compressed air, the rotating air being a portion of the compressed air.

18. The aircraft of claim 15, wherein the plurality of fan blades is rotatable about the rotational axis to generate a column of propulsor discharge air, the lift fan assembly being oriented on the aircraft such that the column of propulsor discharge air produces lift.

19. The aircraft of claim 15, wherein the lift fan assembly is one lift fan assembly of a plurality of lift fan assemblies, each lift fan assembly of the plurality of lift fan assemblies comprising
a fan including:
a plurality of fan blades rotatable about a rotational axis in a circumferential direction, the plurality of fan blades extending outward in a radial direction from the rotational axis. each of the plurality of fan blades having a fan blade tip;
an outer band including an inner surface and an outer surface, the outer surface located radially outward of the inner surface, the outer band circumscribing the plurality of fan blades, wherein the fan blade tips are connected to the inner surface of the outer band;
a plurality of outer airfoils extending radially outward from the outer surface of the outer band, wherein the plurality of outer airfoils are configured to rotate about the rotational axis in the circumferential direction to rotate the plurality of fan blades; and
an inlet nozzle positioned and oriented to direct rotating air in a rotating airflow direction to impinge on outer airfoils of the plurality of outer airfoils and to rotate the plurality of outer airfoils, thereby rotating the plurality of fan blades, the rotating airflow direction being transverse to the radial direction and having a component in a direction tangential to the circumferential direction.

20. The aircraft of claim 19, wherein the inlet nozzles of the plurality of lift fan assemblies are fluidly connected in parallel with each other to a rotating air source.
